(19) United States
(12) Patent Application Publication
(10) Pub. No.: US 2021/0281103 A1
(43) Pub. Date: Sep. 9, 2021

(54) Integrated Solar PV Module-Level Energy Storage and Associated Power Control System

(71) Applicant: Yotta Solar, Inc, Austin, TX (US)

(72) Inventors: Bertrand Jeffrey Williams, Austin, TX (US); Vikram N. Iyengar, Austin, TX (US)

(73) Assignee: Yotta Solar, Inc, Austin, TX (US)

(21) Appl. No.: 16/859,999

(22) Filed: Apr. 27, 2020

Related U.S. Application Data
(60) Provisional application No. 62/838,882, filed on Apr. 25, 2019.

(51) Int. Cl. H02J 7/35; H02J 3/38

(52) U.S. Cl. CPC H02J 7/35; H02J 2300/26; H02J 3/381

(57) ABSTRACT

A system includes a power electronics and storage device coupled to one or more photovoltaic (PV) modules, one or more batteries, and an output power bus. The power electronics storage and storage system includes power electronics configured to control a voltage/current curve at an output port according to a selected operating mode of a plurality of operating modes. The operating modes one or more of a PV emulation mode, a parallel and series connection mode, a battery emulation mode, a battery cell voltage scaling mode, or other modes. The power electronics may include a microcontroller to control one or more of a port voltage at an output port and a common voltage at a shared or common node to manage power flow to, from, and between a PV port, a battery port, and the output port.

This application is a non-provisional of and claims priority to U.S. Provisional Patent Application No. 62/838,882 filed on Apr. 25, 2019 and entitled “Integrated Solar PV Module-Level Energy Storage and Associated Power Control System”, which is incorporated herein by reference in its entirety.

### FIELD

The present disclosure is generally related to solar power systems, and more particularly to an integrated solar photovoltaic (PV) module level energy storage and associated power control system that may enable bi-directional current flow into and out of an output port of a PV module.

### BACKGROUND

Solar panels typically convert light into a direct current (DC) and voltage power supply (P_{PV}), which may be coupled to a power bus in series or in parallel with other solar panels of an array of solar panels.

### SUMMARY

Embodiments of an integrated photovoltaic (PV) device may utilize one or more switching circuits to shift or adjust a relative voltage target between a common voltage node and a port voltage. This adaptive power flow control may enable several operating modes, which may be selected automatically, or which may be selected based on signals from a control system. The operating modes may include a PV emulation mode, a parallel or series mode, a battery emulation mode, and a battery cell voltage scaling mode. In the PV emulation mode, the PV device may emulate the voltage/current curve such that attached maximum power point tracking (MPPT) converters may be coerced to a selected power level. In the parallel or series mode, the PV device may maintain a state of charge level within a selected range by communicating with other PV devices to selectively and independently control power flow. In the battery emulation mode, the PV device may generate a battery voltage output profile representative of a Lead-Acid based state of charge cover. In the battery cell voltage scaling mode, the integrated PV device may regulate the output voltage level to track a selected voltage level to emulate a battery with a selected series cell height. Other modes are also possible.

Embodiments of an integrated PV device may be coupled between a solar panel and the power bus and that may include an integrated battery. The integrated PV device may include a multiport power conversion unit, including a PV port to couple to a solar panel, a battery port to couple to a battery, and an output port to couple to the power bus. The multiport power conversion unit may provide extensive flexibility in management of the power flow between the various ports. In some implementations, the integrated PV device may manage power flow using a multitude of single stage switching converters connected to a common port or node. Each converter may be controlled to regulate the power flow into or out of its external port relative to the common port. Since power is conserved at the common port or node, the sum of power flowing into the common port or node is equivalent to the power flowing out of the common port or node. Power may thus be controlled in order to achieve a selected control situation.

The integrated PV device may support various modes of operation. For example, in a recharge mode, the battery may be charged from the PV port, or the external load port (as a source of power), or both. In a PV plus battery supply mode, the battery may supply power to the load to supplement power from the PV port, if the PV has sunlight available. In a battery mode, the battery may supply power to the load. Thus, the integrated PV device may be configured to supply power to a load twenty-four hours per day and effectively allow an otherwise intermittent PV source to act as a stable power source.

In some implementations, the integrated PV device may have three ports: a PV port, a battery port, and an output port to couple to the load. However, the integrated PV device is not limited to strictly three ports and could be easily extended to support various other sources or destinations of power. For example, the integrated PV device may include a fourth port to supply power to a supplemental load, such as a heater. When ambient temperatures drop below a threshold temperature (such as a desired temperature for operation of the battery), the integrated PV device may supply power to the fourth port to supply power to a heater configured to maintain a selected the battery temperature. The fourth port, and optionally other additional ports, may be supplied differently from the PV port, the battery port, and the output port.

The configurations and control capability of the integrated PV device may provide for a superior flexibility and adaptability into various application configurations, which otherwise might not be possible without restrictions upon usability. Further, the flexibility and adaptability of the integrated PV device may be achieved with a high switching power conversion efficiency by utilization of the simple of power conversion techniques and circuit configurations, which may be independently controllable and configurable dynamically.

The integrated PV device may include an integrated microcontroller configured to manage operation of the device based upon local measurements (including, but not limited to, voltages, currents, temperatures, and so on). In some implementations, the integrated PV device may control and manage operation using Pulse-Width Modulated (PWM) output signals, which may be used to drive switching circuitry in one or more power conversion stages. Utilizing local measurement data of the state of the integrated PV device, the integrated microcontroller may generate the PWM signals to manage the power flow within the converters to achieve desired operational conditions and responses.

In some implementations, the integrated microcontroller of the integrated PV device may be configured to operate autonomously with a specified set of parameterized response algorithms. The integrated PV device may also be connected to a communications interface to send measurement and status information to an external control system and to receive command data, including parameter adjustments, control system functional modifications, updates to one or more of the parameterized response algorithms, other data, or any combination thereof.

In some embodiments, a power electronics and storage system may include a PV port to couple to a PV module, a battery port to couple to one or more batteries, an I/O port to couple to a power bus, and a shared port. The system may further include a PV port converter coupled between the PV port and the shared port, a battery port converter coupled between the battery port and the shared port, and an output port converter coupled between the I/O port and the shared port. The system further includes a microcontroller coupled to the PV port converter, the battery port converter, and the output port converter to control one of a port voltage at the I/O port and a common voltage at the shared port to manage power flow to, from, and between the PV port, the battery port, and the I/O port.

In other embodiments, an array specific (or region of the array specific) base station may monitor the status and conditions of both the energy storage systems and power electronics units across the array. One or more inverters attached to the array may provide sophisticated control for improved energy management and improved battery State of Charge (SoC) and/or State of Health (SoH) management and monitoring of the system.

In still other embodiments, the base station, or a cloud connected server, may include one or more algorithms that may be used to determine how power flow is directed within the array between the units, from the units to the inverter(s), from the inverter(s) to the units, bi-directionally to and from the attached grid, or any combination thereof. These algorithms may be designed to be the master of the system, or slave to an attached energy value-based management system or slaved to the inverter(s) for such decision-making. Other implementations are also possible.

Possible simplifications and alternative architectural methods of controlling the power flow are provided in the discussion and figures to follow.

### BRIEF DESCRIPTION OF THE DRAWINGS

The detailed description is set forth with reference to the accompanying figures. In the figures, the left most digit(s) of a reference number identifies the figure in which the reference number first appears. The use of the same reference numbers in different figures indicates similar or identical items or features.

FIG. 1 depicts a block diagram of a PV series power and storage system with an integrated power electronics and storage module, in accordance with certain embodiments of the present disclosure.

FIG. 2 depicts a block diagram of a PV parallel power and storage system with an integrated power electronics and storage module, in accordance with certain embodiments of the present disclosure.

FIG. 3 depicts a block diagram of a portion of a system including power electronics and storage, in accordance with certain embodiments of the present disclosure.

FIG. 4 depicts a block diagram of a power electronics circuit, in accordance with certain embodiments of the present disclosure.

FIG. 5 depicts a circuit diagram of power flow between converters of the power electronics, in accordance with certain embodiments of the present disclosure.

FIG. 6 depicts a graph of voltage versus time for a common voltage and a port voltage of the power electronics in a forward mode, in accordance with certain embodiments of the present disclosure.

FIG. 7 depicts a graph of voltage versus time for a common voltage and a port voltage of the power electronics in a reverse mode, in accordance with certain embodiments of the present disclosure.

FIG. 8 depicts a block diagram of the power electronics including a fourth port to power one or more heater elements, in accordance with certain embodiments of the present disclosure.

FIG. 9 depicts a block diagram of a portion of a battery interconnect circuit that may provide a battery disconnect and soft-connect feature, in accordance with certain embodiments of the present disclosure.

FIG. 10 depicts a diagram of a battery soft connect circuit that may be included in the power electronics, in accordance with certain embodiments of the present disclosure.

FIG. 11 depicts a block diagram of power electronics with a PV port converter and an output port converter and without a battery port directly coupled to a common node, in accordance with certain embodiments of the present disclosure.

FIG. 12 depicts a block diagram of a system including a PV array and a control system configured to communicate via a network, in accordance with certain embodiments of the present disclosure.

While implementations are described in this disclosure by way of example, those skilled in the art will recognize that the implementations are not limited to the examples or figures described. The figures and detailed description thereto are not intended to limit implementations to the form disclosed, but on the contrary, the intention is to cover all modifications, equivalents, and alternatives falling within the spirit and scope as defined by the appended claims. The headings used in this disclosure are for organizational purposes only and are not meant to limit the scope of the description or the claims. As used throughout this application, the word “may” is used in a permissive sense (in other words, the term “may” is intended to mean “having the potential to”) instead of in a mandatory sense (as in “must”). Similarly, the terms “include”, “including”, and “includes” mean “including, but not limited to”.

### DETAILED DESCRIPTION OF ILLUSTRATIVE EMBODIMENTS

Embodiments of a power electronics and energy storage system are described below that may be comprised of a plurality of half-bridge power converters, each of which may include a first port and a second port. The second port of each of the half-bridge power converters may be coupled to a common node. In this configuration, the switching power stages may have enhanced switching power efficiency, cost efficiency, and space efficiency as compared to conventional devices. In some implementations, the power electronics and energy storage system may provide flexibility over the control of power flow to, from, and between any of the half-bridge power converters.

In some implementations, an integrated photovoltaic (PV) device may utilize one or more switching circuits to shift or adjust a relative voltage target between a common voltage node and a port voltage. This adaptive power flow control may enable several operating modes, which may be selected automatically or in response to signals from a control system. The operating modes may include a PV emulation mode, a the parallel or series mode, a battery emulation mode, and a battery cell voltage scaling mode. In the PV emulation mode, the PV device may emulate the voltage/current curve such that attached maximum power point tracking (MPPT) converters may be coerced to a selected power level. In the parallel or series mode, the PV device may maintain a state of charge level within a selected range by communicating with other PV devices to selectively and independently control power flow. In the battery emulation mode, the PV device may generate a battery voltage output profile representative of a Lead-Acid based state of charge cover. In the battery cell voltage scaling mode, the integrated PV device may regulate the output voltage level to track a selected voltage level to emulate a battery with a selected series cell height. Other modes are also possible.

In some implementations, the power electronics and energy storage system may control power flow simultaneously through two or more of the ports or at a selected power level from any port of the system to any other port of the system. Any combination of shared power may be redirected towards any port or may be extracted from it. For example, the power electronics and energy storage system may apply power into PV port to heat the PV module (for de-icing) after a snowstorm utilizing power from either the battery or an attached external bi-directional inverter. For example, the power electronics and energy storage system may apply power into PV port to quickly discharge the available energy in the battery in the event of a grid outage to maintain a safe battery level. Such a grid outage may occur in a local fire event, such as a building fire event.

The power electronics and energy storage system may include a local microcontroller with specific algorithms to operate in various modes with differing levels of autonomy. In some implementations, the local microcontroller may be programmable to provide instructions that can be adjusted or re-programmed. Further, the microcontroller may utilize the instructions to operate fully autonomously to allow the PV module to charge the battery, to maintain a selected output voltage level for the output port, and so on.

The control system may be distributed within multiple power electronics and energy storage systems, which can operate in series, in parallel, or any combination of series-parallel configurations with immunity to battery imbalance concerns. In particular, the power electronics and energy storage system may automatically balance and match battery systems.

Additionally, in some implementations, the integration of a heating element, which may be driven by power from one or more of the ports of the power electronics and energy storage system may allow the system to operate at very low temperature extremes. In some implementations, the system may allow for stable operation in very low temperature conditions by allowing internal or external power to heat the battery to safe temperatures, in conjunction with redirecting power from any source available.

A distributed Energy Storage System, with a Battery attached to a PV module, and wired into a power distribution array, may allow for 24 hours, or on demand, energy delivery, and/or time-based power control supplemented with daily PV energy capture. It has been rare to find batteries placed underneath and or in proximity to, and with a one-to-one correspondence to PV modules for various reasons, both environmental, and due to the complexity of controlling the power flow, which may be resolved with this power electronics system. There are multiple ways to configure and wire such a PV-based distributed Battery Energy Storage system. The first is as a PV Array with multiple high-voltage series DC strings wired in parallel. The power flow control capabilities of this system allow it to be configured and wired as a conventional PV array with few or no changes, thus allowing retrofit in addition to new installation opportunities. A second example would be in a typical parallel DC Battery arrangement.

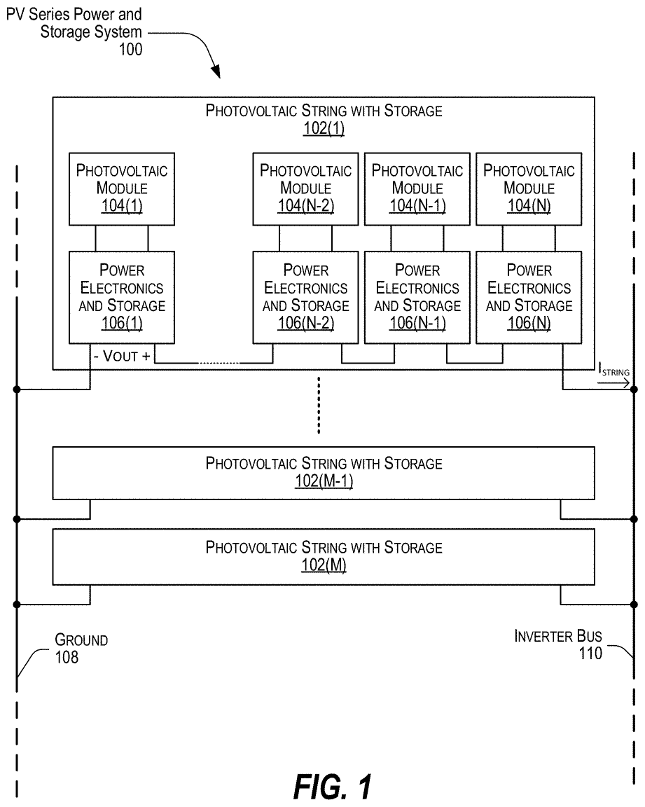

It should be appreciated that the power electronics and energy storage system may be integrated in an energy storage device, which may be coupled between a PV module, a battery, and an output. One possible example of a serial implementation of a PV array is described below with respect to FIG. 1.

FIG. 1 depicts a block diagram of a PV series power and storage system with an integrated power electronics and storage module, in accordance with certain embodiments of the present disclosure. The system 100 may include a plurality of photovoltaic strings with storage 102. Each PV string with storage 102 may include a plurality of PV modules 104. Each PV module 104 may be coupled to a power electronics and storage module 106. The power electronics and energy storage modules 106 may be arranged in series between a ground connection 108 and an inverter bus 110.

In the illustrated example, it should be appreciated that the PV string with storage 102 may include any number of PV modules 104 and associated power electronics and energy storage module 106, constrained only by design considerations. Further, in the illustrated example, the power electronics and energy storage module 106(1) includes a first terminal coupled to the ground 108 and a second terminal coupled to a first terminal of a next power electronics and energy storage module 106 in the series.

In the illustrated example, the system 100 is shown from a system-level perspective with a number (N) of PV modules 104 in series within each PV string with storage 102. Further, the system 100 may include a number (M) of PV strings with storage 102 in parallel.

Each of the power electronics and storage modules 106 may include a battery-based energy storage system within the PV array, which allows for selected functionality with respect to existing wiring systems. In some implementations, the power electronics and storage module 106 may include a conventional PV inverter if desired, allowing the PV array (comprised of the PV strings with storage 102) to generate power 24 hours per day, if desired. In some implementations, the power electronics and storage module 106 may include a bi-directional inverter to allow for utilization of grid power, PV power, or both to charge the batteries, and to allow for 24-hour power delivery.

In the illustrated example, the sum of the output voltages (V_{OUT}) for each of the power electronics and storage modules 106 equates to the inverter bus voltage V_{BUS}, which is common for every string. Each power electronics and storage module 106 within each PV string 102 provides a common current (I_{OUT}) will have a common Iout, and since the power electronics and storage module 106 are arranged in series, the output current (I_{OUT}) is equal to the string current (I_{STRING}) for a given one of the PV strings 102. However, the string current (I_{STRING}) for PV string with storage 102(1) may differ from that of PV string with storage 102(M−1). Thus, the string current (I_{STRING}) for each PV string with storage 102 may be different from the other PV strings with storage 102.

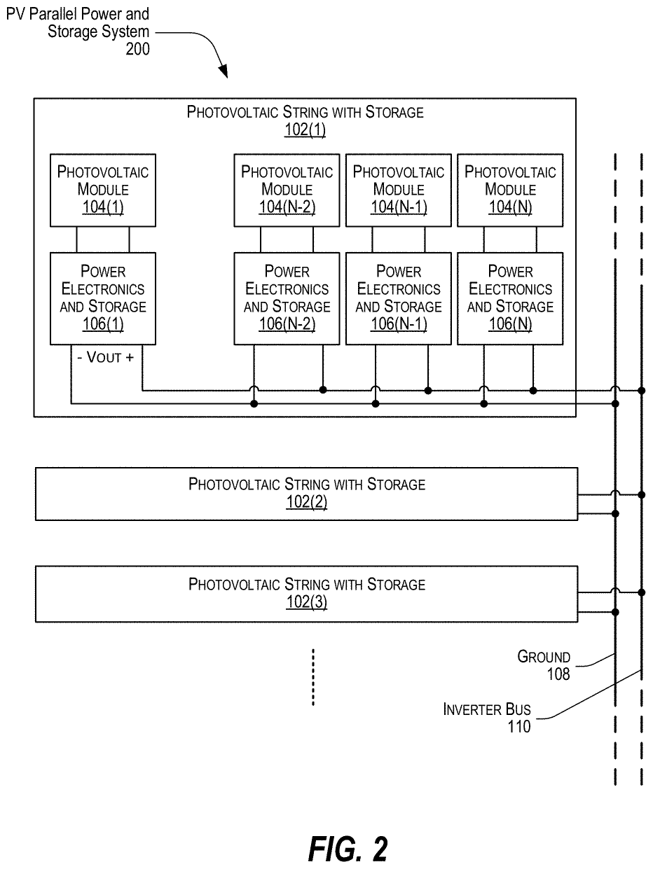

While the power electronics and storage module 106 is shown in a series configuration with the PV strings with storage 102 arranged in parallel, other configurations are also possible, such as a parallel architecture or a hybrid parallel and series architecture. One possible example of a parallel implementation is described below with respect to FIG. 2.

FIG. 2 depicts a block diagram of a PV parallel power and storage system 200 with an integrated power electronics and storage module 106, in accordance with certain embodiments of the present disclosure. In this example, each PV string with storage 102 may include a plurality of PV modules 104 and a corresponding plurality of power electronics and energy storage modules 106. In this example, each of the power electronics and storage modules 106 may be coupled between the ground 108 and the inverter bus 110.

In this configuration of parallel sets of series strings, the system 200 may be compatible with most solar PV arrays in utilization, wiring, and usage. In this configuration, the power electronics and storage module 106 may allow for charging of the batteries from the inverter bus into the power electronics and storage module 106 in addition to normal forward power delivery from the PV modules 104 (and optionally integrated batteries) to the inverter bus, which may now be available 24 hours a day.

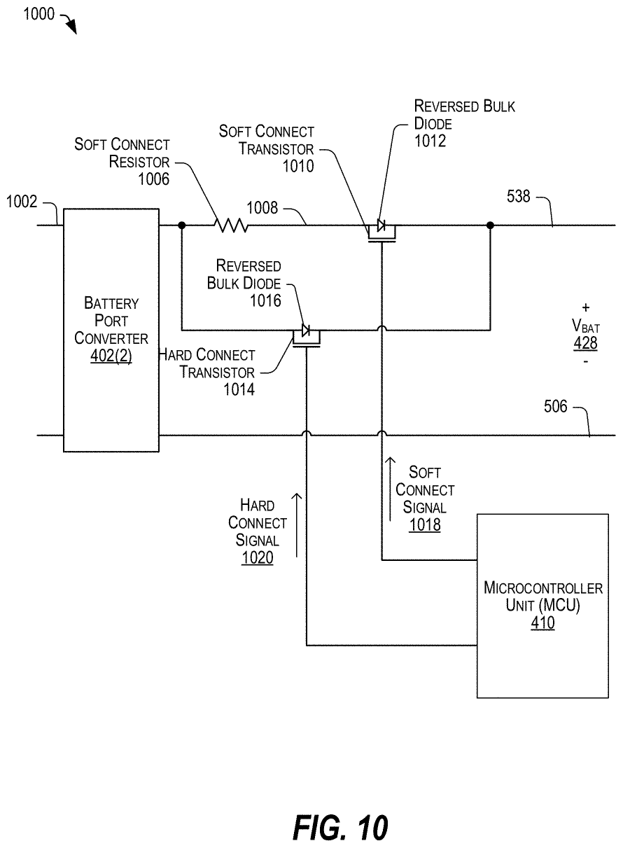

In some implementations, in the parallel configuration of the system 200 of FIG. 2, an appropriate initialization sequence may use a battery port soft-connect circuit (shown in FIG. 10). The soft-connect initialization may prevent excess battery currents when the system 200 is first connected and enabled. The soft-connect circuit may also be useful for series/parallel string configurations, since power flow can still be present across the parallel strings. This soft-connect feature and the series/parallel configuration flexibility are enabled by the multi-port power electronics and storage module 106, which is unique for reliable and safe battery system connectivity and initial balancing of mismatched battery units.

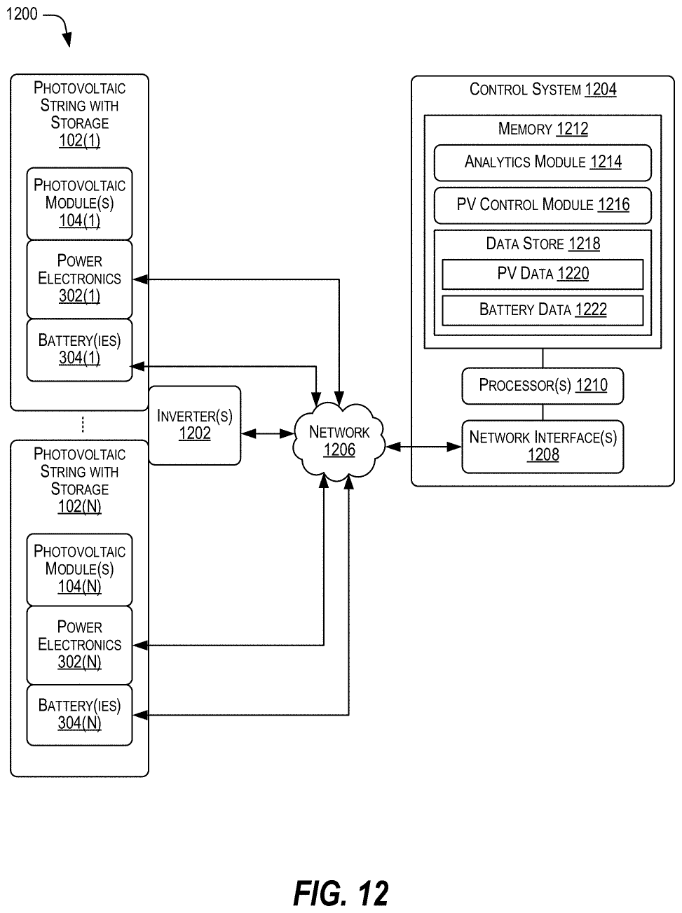

The examples described above with respect to FIGS. 1 and 2, the power electronics and storage 106 may utilize one or more switching circuits to shift or adjust a relative voltage target between a common voltage node and a port voltage. This adaptive power flow control may enable several operating modes. The operating modes may include a PV emulation mode, a parallel or series mode, a battery emulation mode, and a battery cell voltage scaling mode. The power electronics and storage device 106 may select between operating modes automatically or in response to a signal from a control system, such as the control system 1204 in FIG. 12.

In the PV emulation mode, the PV device may emulate the voltage/current curve such that attached maximum power point tracking (MPPT) converters may be coerced to a selected power level. In the parallel or series mode, the PV device may maintain a state of charge level within a selected range by communicating with other PV devices to selectively and independently control power flow. In the battery emulation mode, the PV device may generate a battery voltage output profile representative of a Lead-Acid based state of charge cover. In the battery cell voltage scaling mode, the integrated PV device may regulate the output voltage level to track a selected voltage level to emulate a battery with a selected series cell height. Other modes are also possible.

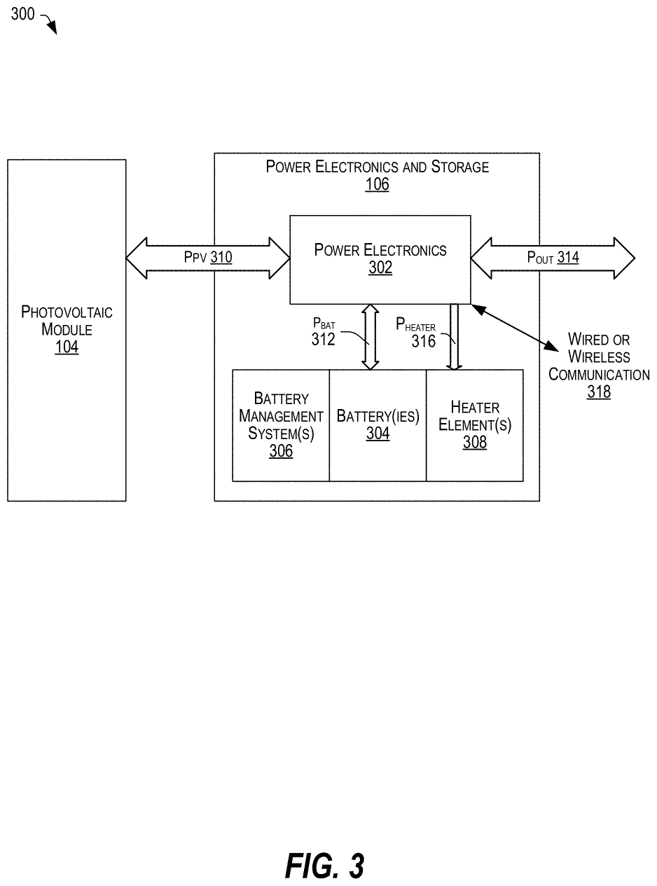

FIG. 3 depicts a block diagram of a portion of a system 300 including power electronics and storage module 106, in accordance with certain embodiments of the present disclosure. The system 300 includes a PV module 104 coupled to the power electronics 302 of the power electronics and storage module 106 via a PV port to receive or to provide a PV voltage and PV current, which are represented by a PV power supply (P_{PV}) 310. The power electronics and storage module 106 may include one or more batteries 304, one or more battery management systems 306, and one or more heater elements 308. Further, the power electronics 302 may be coupled to an inverter bus 110 through an output port to provide or receive an output voltage and an output current, which are represented by an output power supply (P_{OUT}) 314. Further, the power electronics 304 may by coupled to the one or more batteries 304 through a battery port to provide or receive a battery voltage and battery current, which are represented by a battery power supply (P_{BAT}) 312. In some implementations, the power electronics 304 may be coupled to one or more heater elements 308 through a switch connection to provide a power supply (P_{HEATER}) 314. Other ports and other implementations are also possible.

In some implementations, a PV module 102 may be coupled to the power electronics 302, to one or more batteries 304, and to an associated Battery Management System (BMS) 306. Output power (P_{OUT}) 314 may be presented to an output (load) port. PV power (P_{PV}) 310 may be provided to or received from a PV module 102. Battery power (P_{BAT}) 312 may be provide to or received from one or more batteries 304. In some instances, the power electronics 302 may provide heater power (P_{HEATER}) 316 to one or more heater elements 308, for example, to cause the heater elements 308 to dissipate heat to defrost the PV module 102.

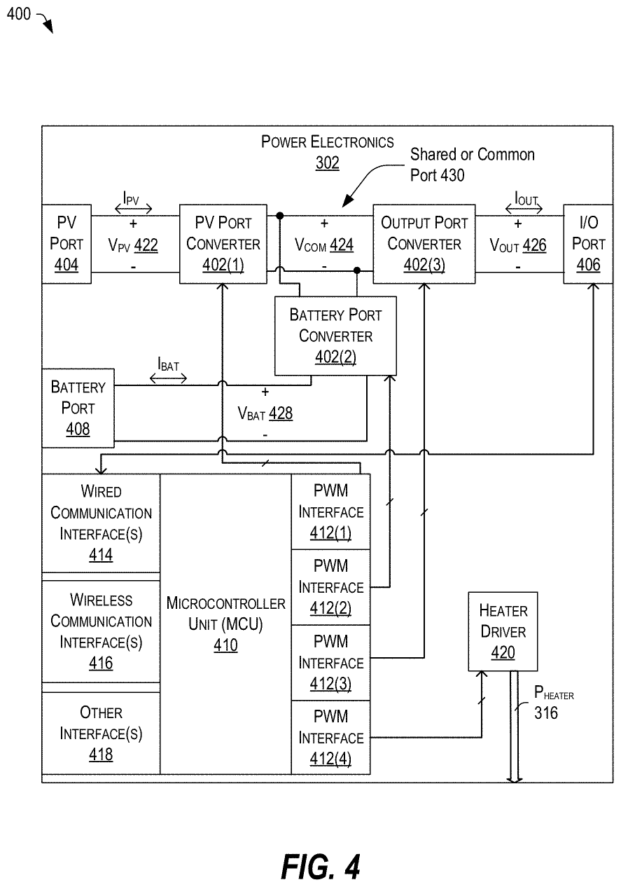

In some implementations, the voltage at the output port may be regulated by an integrated microcontroller. The microcontroller may generate one or more pulse-width modulated (PWM) signals to one or more half-bridge transistor circuits to maintain an effective voltage/current (V/I) curve at the output port. In this example, the microcontroller may coerce the inverter to behave as if the inverter were attached to a PV array rather than to a distributed power electronics and storage module 106. One possible implementation of the power electronics and storage module 106 including a microcontroller is described below with respect to FIG. 4.

FIG. 4 depicts a block diagram 400 of the power electronics 302, in accordance with certain embodiments of the present disclosure. The power electronics 302 may include a first port converter 402(1) coupled to a PV port 404, which may be coupled to a PV module 104. The first port converter 402(1) and the PV port 404 may be coupled by a pair of conductors, which carry a PV voltage (V_{PV}) 422 and a PV current (Irv). The first port converter 402(1) may be coupled to a shared or common conductor pair, which carry shared or common voltage (V_{COM}) 424.

The power electronics 302 may include a second port converter 402(2) coupled to the shared or common conductor pair. The second port converter 402(2) may be coupled to a battery port 408 through a conductor pair, which may carry a battery voltage (V_{BAT}) 428 and a battery current (I_{BAT}). The power electronics 302 may further include a third port converter 402(3), which may be coupled to the shared or common conductor pair. Additionally, the third port converter 402(3) may be coupled to an input/output (I/O) port 406 by a pair of conductors, which may carry an output voltage (V_{OUT}) 426 and an output current (I_{OUT}).

The power electronics 302 may further include a microcontroller unit (MCU) 410, which may include or be coupled to a plurality of PWM interfaces 412 and which may control the PWM interfaces 412 to send PWM signals to the various port converters 402, and optionally to a heater driver 420. A first PWM interface 412(1) may be coupled to the port converter 402(1). A second PWM interface 412(2) may be coupled to a second port converter 402(2). A third PWM interface 412(3) may be coupled to a third port converter 402(3). A fourth PWM interface 412(4) may be coupled to the heater driver 420, which may provide a heater power supply (P_{HEATER}) 316 to the one or more heater elements 308 in response to the PWM signal from the fourth PWM interface 412(4). Other implementations are also possible.

The MCU 410 may also be coupled to one or more wired communication interfaces 414, which may be coupled to one or more other devices through wired connections. In one possible example, the wired communication interface 414 may be coupled to the I/O port 406 to receive modulated communication signals from the inverter bus 110. In some implementations, the MCU 410 may be configured to utilize the wired communication interface 414 to send data (such as commands, parameter data, other information, or any combination thereof) via the I/O port 406. The wired communication interface 414 may further include one or more ports or interfaces, such as universal serial bus (USB) ports, other serial ports, Ethernet ports, other ports or connectors, or any combination thereof. In some implementations, the wired communication interface 414 may use Power Line Communications (PLC) to send and receive data, parameters, instructions, or any combination thereof via the I/O port 406. Other implementations are also possible.

Further, the MCU 410 may be coupled to one or more wireless communication interfaces 416, which may be communicatively coupled to one or more other devices through wireless communications. In one possible example, the wireless communication interface 416 may communicate with other devices using radio frequency signals, optical signals, or any combination thereof. In some implementations, the wireless communication interface 416 may include one or more radio frequency (RF) transceivers that may be configured to send and receive wireless signals through a short-range communications link (such as Bluetooth®, Zigbee®, IEEE 802.11x, or other short range wireless communications links or networks), a long-range or wide area communications link (such as cellular, digital, satellite, or other long range communications network), other wireless communications, or any combination thereof.

Further, the power electronics 302 may include one or more other interfaces 418, which may be used to couple the power electronics 302 to other devices, other systems, or any combination thereof. Other implementations are also possible.

The MCU 410 may control the PWM interfaces 412 to send variable PWM signals. For example, the MCU 410 may use the PWM interface 412(1) to send a variable PWM signal to the port converter 402(1) and may use the PWM interface 412(2) to send a variable PWM signal to the port converter 402(2) to control power transfer from the PV port 404 to the battery port 408. One or more other PWM signals, such as to the port converters 402(2) and 402(3), may control power transfer between the battery port 408 and the I/O port 406.

It should be appreciated that the port converters 402 may be controlled to allow power to flow in either direction. A few example modes of operation are described below, each with varying levels of autonomous operation. The modes described below are illustrative only and are not intended to be limiting. Other operating modes may also be included.

In one possible example, the MCU 410 may utilize a maximum power point tracking (MPPT) algorithm to send PWM signals to the port converter 402(1), then the port converter 402(3) may control the direction of power transfer from the PV module 102 module to the inverter bus 110 or the reverse. It should be appreciated that integration of the MCU 410 allows for deterministic control of power flows into and out of the power electronics 302 by the regulation of the port voltages at the three ports (PV port 404, I/O port 406, and battery port 408) of the power electronics 302, or by regulating the common shared port 430. Since the common voltage (V_{COM}) 424 can be allowed to be at any voltage above the battery voltage (V_{BAT}) 428, the common voltage (V_{COM}) 424 may adapted for optimal voltage levels to work with the PV module 102 and output system attached to the I/O port 406, up to voltages allowed by the particular implementation.

In a cold weather implementation, the power electronics 304 may support cold weather snow clearing by utilizing the battery power (PEAT 312) to melt snow on the PV modules 102, pushing power back into the attached PV module 102 (for example, at night, before sunrise so that the PV module 102 are cleared by sunrise). The power may be driven to the PV modules 108 using battery power or power form the I/O port (from other unit batteries or the inverter/grid) to melt snow or otherwise defrost the PV module 102. By driving the PV voltage (V_{PV}) 422 to a voltage level that is greater than a PV open circuit voltage, current and voltage may flow into the PV module 102, causing power dissipation and heating of the PV module 102, which may melt snow from the PV module 102.

When the power electronics 302 (and the system 100 or 200 as a whole) is connected to an Internet service through the wired communication interface 414 or the wireless communication interface 416, the power electronics 304 may receive control information that can be used to adjust operation to manage the power transfer. In one possible implementation, a control system (such as one or more servers coupled to the Internet, a cloud-based system, or a central computing device) may be configured to determine one or more parameters to enhance overall efficiencies and performance based on various factors, including energy value, energy cost, time-of-day, weather conditions, load attributes, other factors, or any combination thereof. In some implementations, the power electronics 302 may manage the power transfer and storage desired per algorithms running in the power electronics 302, a control system, other devices, or distributed across the system operating in unison.

In a command control mode, the system 100 or 200 may deliver power based upon an external commanded operation condition received by one or more of the power electronics 302 within the PV strings 102. The power transfer through the port converters 402 as well as the operating voltages and currents may be controlled based on the external commands, which may send data and optionally control signals based on parameters of the system 100 or 200 as a whole and which may utilize a higher level decision-making strategy, as opposed to an autonomous distributed decision-making strategy. In the command control mode, the control system may control power delivered or charged, assess the state of charge and PV production dynamically, and send control signals to one or more of the power electronics 302 to adjust the operation accordingly. The command control mode may be combined with otherwise autonomous operating modes to provide simplified autonomous operation with dynamic adaptation based upon system-level condition changes. The control system may also change between various autonomous modes based upon production demands and availability to optimize the operation. In general, an autonomous mode may be more responsive, and rules based, whereas the centralized commanded modes may be generally less responsive but may allow more precise control and adaptation, thus a central control system may be used in conjunction with distributed microcontrollers 410 in each of the power electronics 304.

In a battery emulation mode, the I/O port 406 may emulate the characteristics of a battery system and then connect such a system to an inverter designed to work with such a system. In the battery emulation mode, the output voltage (V_{OUT}) 426 provided at the I/O port 406 may be relatively fixed around a selected operating voltage such that an external load pulling the voltage below this selected operating voltage causes the power electronics 304 to deliver power commensurate with the load up to the limit of the capacity of the system 100 or 200. The limit of the capacity may be a programmable threshold.

If the MCU 410 of the power electronics 302 wishes to charge the batteries 304, the power electronics 302 may raise the common voltage (V_{COM}) 424, and the power electronics 302 will attempt to pull power from the charging inverter bus 110 to charge the local batteries 304. This mode is capable of bidirectional charging from the grid-tied inverter via the inverter bus 110 as described above by adapting the output converter ratio to obtain voltage ratios between the common voltage V_{COM} 424 and the output voltage V_{OUT} 426 to provide the battery voltage (V_{BAT}) 428. Indirectly, the inverter bus voltage may be adjusted by changing the output voltage (V_{OUT}) 426 for each power electronics and storage module 106 in the series string 102.

In an autonomous solar PV emulation mode, the power electronics 302 may allow only unidirectional power transfer emulating the characteristics of a PV array. Since a PV module only supplies power unidirectionally, it is straightforward for the power electronics 302 to utilize the charging from the PV module 102 and to deplete daytime energy from the PV array (modules 102) to charge the batteries 304 within each power electronics and storage module 106, and then to power the PV array (or the inverter bus 110) from the charge stored in the batteries 304 during evening and night hours.

In some implementations, the MCU 410 may use a current/voltage (I/V) based output power control algorithm to shape the power curve to emulate that of a PV array. By adapting the output voltage (V_{OUT}) by providing PWM signals to one or more of the port converters 402, the current and voltage at the I/O port 406 may have a desired I/V characteristic. Thus, the MCU 410 can control the port converters to charge the batteries and to deliver power to the array 102 based upon a rules-based controls.

In a battery adaptation internal mode, the MCU 410 may control the port converter 402(2) to provide battery adaptation, battery protection, and rebalancing. For example, if a single cell of the battery 304 has failed, the BMS 306 will present a lower voltage battery string. However, when this is sensed by the MCU 410, the battery interface converter 306 may change the voltage ratios to maintain an equivalent voltage presentation to the port converters 402. Thus, a dynamic BMS 306 may be employed, which takes advantage of the potentially variable battery string voltage.

In some implementations, the power electronics 302 may utilize the MCU 410 to control one or more PWM interfaces 412 and switches PV port converter 402(1), the battery port converter 402(2), and the output port converter 402(3) to shift or adjust a relative voltage target between a common voltage node (V_{COM} 424) and a port voltage (e.g., V_{OUT} 426, V_{PV} 422, V_{BAT} 428, or any combination thereof). This adaptive power flow control may enable several operating modes. The operating modes may include a PV emulation mode, a State of Charge mode, a battery emulation mode, and a battery cell voltage scaling mode. In the PV emulation mode, the PV device may emulate the voltage/current curve such that attached maximum power point tracking (MPPT) converters may be coerced to a selected power level. In the parallel or series mode, the PV device may maintain a state of charge level within a selected range by communicating with other PV devices to selectively and independently control power flow. In the battery emulation mode, the PV device may generate a battery voltage output profile representative of a Lead-Acid based state of charge cover. In the battery cell voltage scaling mode, the integrated PV device may regulate the output voltage level to track a selected voltage level to emulate a battery with a selected series cell height. Other modes are also possible.

In the PV emulation mode, a voltage/current (V/I) curve of a PV module may be modeled at the output as a current source in parallel with a series stack of forward-biased diodes, since each cell in a PV Module is a forward-biased large surface area diode, which converts light energy to current. The forward-biased large surface area diode of the PV module shunts that current. In the PV emulation mode, a PV module may deliver maximum power at one operating point on the V/I curve, where the power (P) is the voltage times the current at a maximum level.

Converters attached to PV Modules may utilize control systems to determine the maximum power operating point, sometimes called Maximum Power Point Tracking (MPPT). MPPT may take many forms. In general, MPPT control systems may control the operating voltage (or current) until the power P=V*I is maximized for the PV module at that time.

The PV emulation mode enables the power electronics 302 to coerce an attached MPPT controlled converter by presenting a V/I characteristic that causes the MPPT converter to move the operating point to a selected level. In this manner, the power electronics 302 may control the amount of power flow that is transferred though the output port (I/O port 406) to a converter, which for all practical purposes thinks it is attached to a PV module. Such systems may include PV inverters, PV microinverters, PV optimizers, or any combination thereof.

In order to perform this coercion, the power electronics 302 may emulate the V/I curve of a PV module sufficiently to present an operating point where power is maximized at a selected V/I point and may present a V/I slope of appropriate nature as the operating point is moved.

In practice, an actual PV module is a continuous time linear system with relatively high bandwidth of response. In other words, if the voltage or current is changed, the resulting operating point conditions are adjusted per the V/I curve with very little phase shift in time. The power electronics 302 may represent a discrete time control system, which may implement a fast algorithm to adapt the operating point at sufficient speed to be faster than a probing control system of the MPPT converter. Most modern MPPT converters, especially inverter-based converters, utilize a probe based upon a 50 Hz or 60 Hz inverted AC load ripple, which reflects to the DC port as a 50-60 Hz or 100-120 Hz ripple voltage waveform. The AC load ripple may be processed to determine a differential impedance slope (or power) to determine which direction to move the operating point to maximize the power transferred (towards the Maximum Power Point). Accordingly, in the PV emulation mode, the power electronics may present a delta voltage in response to an applied voltage with a phase shift which is small at 120 Hz, which may be based on a control bandwidth of some multiple of 120 Hz (5-10×). Thus, the MPPT converter may be coerced to move its operating point toward a selected maximum power point.

A PV module may present a logarithmic linear V/I curve to the load, but in practice, it is not necessary to implement such a smoothly logarithmic curve, since the goal of the power electronics 302 may be to move to a specific operating point. It is sufficient to present a pair of linear straight line “curves”, which may intersect at the selected maximum power point. Since such straight line “curves” may be simple to implement, the MCU 410 of the power electronics 302 may easily provide the control functionality at substantially higher frequency than the 120 Hz bandwidth speeds (e.g., 1 KHz-2 KHz or higher frequency) with very simple controllers.

In some implementations, there may be a conversion between the selected power level and the V/I curve to achieve a selected output. The output port (I/O port 406) of may have constraints for optimal operation when connected to a system, which is designed to be attached to a PV module. By following the constraints based upon actual PV modules which would have optimal characteristics as a function of a desired power level, it is possible to determine a set of parameters that represent an optimal (or sufficient) V/I curve for a selected power level. The parameters that define a PV module may include Voc (open-circuit, voltage at load current=0), Vmp (voltage at the maximum power point), Isc (short circuit, current at load voltage=0), and Imp (current at the maximum power point).

In one example, the parameters may be converted as follows First, parameters may be defined as follows: Vmax (maximum allowed output port voltage), Imax (maximum allowed output port current), Pmax (maximum allowed output port power), Pmin (minimum allowed modeled output power), and Vmin (minimum output voltage to maintain operation of the attached converter). A selected or target power level may be defined as Ptarget. The MCU 410 may determine the parameters according to the following Pseudo code.

PSEUDO Code Example 1.

// if the selected target power level is less than or equal to the minimum
allowed modeled
//output power

if Ptarget <= Pmin

Vmp = Vmin
Imp = Pmin / Vmp

//Otherwise, if the selected target power level is between the minimum
allowed modeled
//output power and the maximum allowed output port power

else if Pmin < Ptarget < Pmax

Vmp = Vmin + ( (Ptarget−Pmin)*(Vmin/(Pmax−Pmin)) )
Imp = Ptarget / Vmp

//Otherwise, if the selected target power level is greater than the maximum
allowed
//output port power

else if Ptarget > Pmax

Vmp = Vmax
Imp = Imax

Voc = 1.25 * Vmp
Is = 1.25 * Imp

The V/I curve may be generated by the MCU 410 by controlling one or more switches of the output port converter 402(3). The MCU 410 may calculate the straight-line curves. The resultant may resemble three operating points with straight lines connecting these operating points, with curve lines A and B, each of which may be described by the following linear equation:

y=mx+b (Equation 1)

where y is a value along the y-axis, x is a value along an x-axis, m is the slope of the line, and b is the y intercept. In this equation, the variable y represents the output target voltage Vout, which is the target for the MCU 410 to regulate Vout for the output port, and X is the measured output current (Iout−meas), which can be determined using the following control algorithm. The control algorithm is depicted in pseudo code for illustrative purposes but is not intended to be limiting. Other control algorithms may be used.

PSEUDO Code Example 2.

Isc=0;
Imp,Vmp;
x = Iout.meas
y = Vout.target
Voc=0
//Control algorithm:

mA = (Vmp−Voc)/Imp
bA = 0
mB = Vmp/(Imp−Isc)
bB = Vmp − (mB * Imp)
if (iMeas < Imp) // use curve ‘A’

Vout.target = (Iout.meas* mA) + Voc

else // use curve ‘B’

Vout.target = (Iout.meas* mB) + bB

When power is calculated from the above equations depicted in pseudocode, it can be observed that the MPPT is very close to the Vmp,Imp location. If the MCU 410 bandwidth exceeds 1-2 Khz or so, the power electronics 302 should be fast enough to adapt the output voltage at the I/O port 406 faster than the probing control system of the MPPT converter coupled to the I/O port 406. In some implementations, the MCU 410 may have an ADC sampled at 50-100 uS, and running a 50-100 uS calculation/regulation interval, and appropriate filters for stability, this PV emulation is easily implemented.

In the parallel or series mode, variations in the output of the PV modules can be readily handled. In conventional PV systems, output voltages of the batteries may be independently regulated. Small variations in component tolerances between units seldom will result in precisely the same exact voltage for any units. Given that battery systems and output voltage regulated converters may exhibit low output impedances, slight differences in output voltages in a parallel implementation may result in substantial (undesired) currents. The power electronics 302 may control the power level within a range for each subsystem (in parallel or in series) to provide a selected power level.

Since the power electronics 302 of each PV module can detect its own state of charge and can communicate with the power electronics 302 of other PV modules or with a control system (such as the control system 1204 in FIG. 12), which may have knowledge of each and every unit. The data may be used by the control system to continually adapt each unit to shuffle power as necessary to maintain a state of charge across all units in parallel (or series) within a selected range.

The control system may monitor the state of charge and may selectively issue commands to specific PV modules to adapt their output port voltages such that more power flows from (or less power flows to) units with higher state of charge, and less power flows from (or more power flows to) units with lower state of charge. The control system may selectively send commands or control signals to the PV modules as needed.

In the battery emulation mode, while Lithium-Ion (Li-ion) battery systems, especially LiFePO (Lithium ferro phosphate) based systems, may have a very flat voltage versus state of charge to voltage curve. When such systems are attached to inverters that utilize the output voltage to make decisions for initiating charge or discharge cycles, it may be difficult for such systems to maintain desired state of charge conditions because the inverter cannot easily determine when to start or terminate the appropriate sequences.

When utilizing battery systems based upon Lead-Acid batteries, this problem does not exist to such a degree. In some LiFePO-based implementations, the power electronics 302 may control the output to present a battery voltage output profile that resembles a Lead-Acid based state of charge to voltage curve. To provide this output, the power electronics 302 of each PV module may generate a voltage based the state of charge that reflects the state of charge to voltage curve of a Lead-Acid battery. If such systems are wired in parallel (or series), the control system may send signals to control the power electronics 302 of each PV module substantially simultaneously to provide the selected state of charge.

In the battery cell voltage scaling mode, the power electronics 302 may regulate the output voltage such that it continually tracks a mathematical, multiple of the battery voltage, effectively emulating a battery with a different series cell stack height. Battery systems may be built from a series stack of parallel cells. The number of cells in series determines the voltage for the battery system. Conventionally, a battery, with its cell stack height, may not be adaptable for a given application because the voltage is not within the range needed for other components in the system. However, the power electronics 302 may regulate the output voltage such that it continually tracks a mathematical, multiple of the battery voltage, effectively emulating a battery with a selected series cell stack height.

In an example, if the architecture included a battery with 12 cells in series, the voltage range for the LiFePO battery stack would be between approximately 32-42 volts or so. The power electronics 302 may regulate the output voltage dynamically to scale 1.25× to emulate a 15-cell stack height battery system with a voltage range of 40-52.5 volts, which might better fit a conventional 48V inverter input voltage range. The power electronics 302 may dynamically match the inverter architecture.

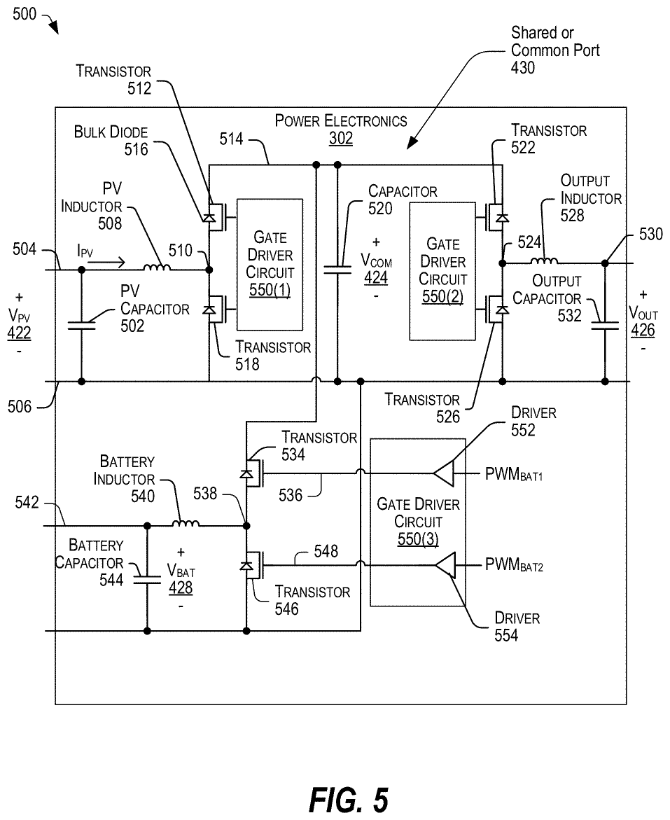

FIG. 5 depicts a circuit diagram 500 of power flow between port converters 402 of the power electronics 302, in accordance with certain embodiments of the present disclosure. The power electronics 302 may include a PV capacitor 502 including a first input coupled to a first node 504 and including a second input coupled to a second node 506. The power electronics 302 may further include a PV inductor 508 coupled between the first node 504 and a node 510.

The power electronics 302 may include a transistor 512 including a first conductor coupled to a node 514, a second conductor coupled to the node 510, a gate coupled to a gate driver 550(1), and a bulk diode 516. The power electronics 302 may further include a transistor 514 including a first conductor coupled to the node 510, a second conductor coupled to the node 506, a gate coupled the gate driver 550(1), and a bulk diode. The transistors 512 and 518, the inductor 508, and the PV capacitor 502 may be part of the port converter 402(1).

The power electronics 302 may further include a capacitor 520 coupled between the node 514 and the node 506. The common voltage (V_{COM}) 424 may be seen across the capacitor 520.

The power electronics 302 may also include a transistor 522 including a first conductor coupled to the node 514, a second conductor coupled to a node 524, a gate coupled to a gate driver 550(2), and a bulk diode. The power electronics 302 may further include a transistor 526 including a first conductor coupled to the node 524, a second conductor coupled to the node 506, a gate coupled to the gate driver 550(2), and a bulk diode. The power electronics 302 may also include an output inductor 528 including a first conductor coupled to the node 524 and a second conductor coupled to a node 530. The power electronics 302 may also include an output capacitor 532 coupled between the node 530 and the node 506. The transistors 522 and 526, the output inductor 528, and the output capacitor 530 may be part of the port converter 402(3).

The power electronics 302 may further include a transistor 534 including a first conductor coupled to the node 514, a second conductor coupled to a node 538, and a gate coupled to a node 536. The power electronics 302 may also include an inductor 540 including a first conductor coupled to the node 538 and a second conductor coupled to a node 542. The power electronics 302 may further include a capacitor 544 coupled between the node 542 and the node 506. The power electronics 302 may also include a transistor 546 including a first conductor coupled to the node 538, a second conductor coupled to the node 506, a gate coupled to a node 548, and a bulk diode. The transistors 534 and 546, the battery inductor 540, and the battery capacitor 544 may be part of the port converter 402(2).

The power electronics 302 may further include a gate driver circuit 550(3), which may be part of the PWM interface 412(2). The gate driver circuit 550(3) may include a first driver 552 including an input to receive a first PWM battery port control signal (PWM_{BAT1}) and an output coupled to the node 536. The gate driver circuit 550(3) may include a second driver 554 including an input to receive a second PWM battery port control signal (PWM_{BAT2}) and an output coupled to the node 548.

In the illustrated example, the power electronics 302 is comprised of a combination of multiple port converters 402 comprised of half bridges of transistors. In the illustrated example, the power electronics 302 includes three port converters 402, but is not necessarily limited to three, depending on the implementation.

Each half-bridge port converter 402 may include a first port and a second port and such that the second ports of each of the port converter 402 are coupled together into a common shared port 430. The first ports for each port converter 402 may represent the external ports for the overall system, connecting to the PV module 102, the output bus 110, and the batteries 304, for example. The power electronics 302 described above may utilize simple half-bridge power stages as port converters 402, providing switching power efficiency, cost efficiency, and space efficiency while achieving complete flexibility over the control of power flow to, from, and between the port converters.

To understand the power-flow through the power electronics 302, it is important to understand the power relationships between the port converters 402 of the power electronics 302. At the outset, the following equations may describe the relationship for power flowing through the power electronics:

P_{OUT}=P_{PV}+P_{BAT}. (Equation 2)

Alternatively, the power may be allowed to be negative, which describes power flowing in the opposite direction, as follows:

P_{BAT}=−(P_{PV}−P_{OUT}). (Equation 3)

In an example, if the PV module power (P_{PV}) 310 is greater than the output power (P_{OUT}) 314, the excess power that is not transferred to the output port of the port converter 402(3) may flow through the port 402(2) into the one or more batteries 304 from the PV module power (P_{PV}) 310 from P_{PV}, and thus the battery power (P_{BAT}) will be negative by this convention. In this example, PV module power (P_{PV}) 310 is positive when it is supplying power to the system. Battery power (P_{BAT}) 312 is positive when it is supplying power or discharging. The output power (P_{OUT}) 314 is positive when the power electronics 302 is supplying power to a load.

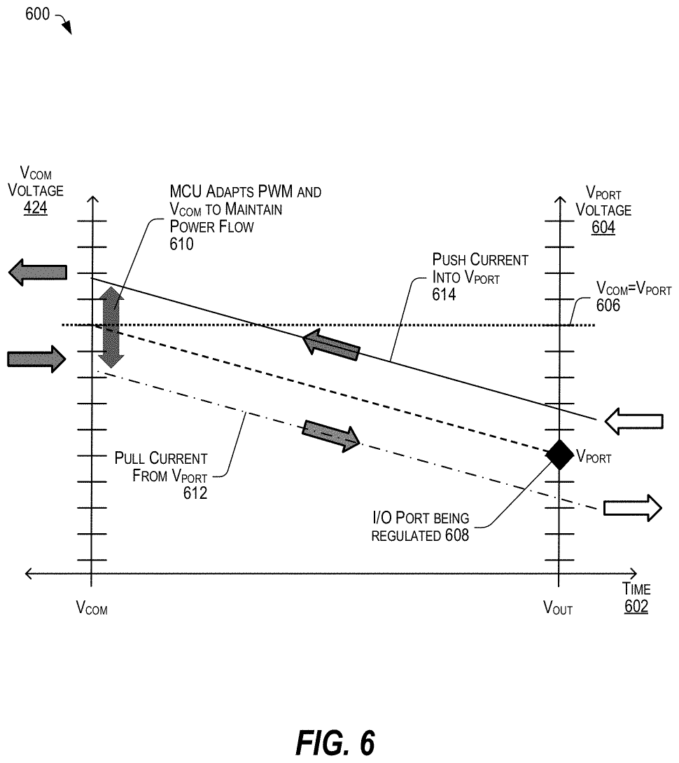

The MCU 410 may be configured to control the gates of the transistors of the half-bridge circuits to control power through the port controllers 402 to maintain a selected voltage at the ports of the power electronics 302. One possible example is described below with respect to FIG. 6.

FIG. 6 depicts a graph 600 of voltage (V_{COM} 424 and V_{PORT} 604) versus time 602 for the power electronics in a forward mode, in accordance with certain embodiments of the present disclosure. In the graph 600, the common voltage V_{COM} 424 is maintained at a level that is greater than the port voltage (V_{PORT}) 604 of any of the ports. In the forward mode, the MCU 410 may adapt the PWM signals to regulate the port voltage (V_{PORT}) 604. The diamond 608 represents the port being regulated.

If the common voltage (V_{COM}) 424 were equal to the port voltage (V_{PORT}) 604, the voltage level would be indicated by the horizontal line 606. In the forward mode, the power flow is regulated, in part, by the load or the source. The microcontroller 410 may adapt the PWM signal to regulate the port voltage (V_{PORT}) 604, as indicated at 610. If the load attempts to pull current from the port (V_{PORT}) 604 as indicated by a line 612, the microcontroller 410 may regulate the PWM signals and the port controllers 402 to increase the common voltage (V_{COM}) to maintain power flow.

In another implementation, if power is pushed into the port, raising the port voltage (V_{PORT}) 604, the common voltage (V_{COM}) 424 may increase to remain above the port voltage (V_{PORT}) 604, as indicated at 614. The port converter 402 into which the port voltage (V_{PORT}) 604 is being pushed may convert the port voltage to another voltage level. Other implementations are also possible.

By regulating the port voltage (V_{PORT}) 604, the microcontroller 410 may adapt the controlling PWM ratio (Ko), which is a ratio of the port voltage (V_{PORT}) 604 divided by the common voltage (V_{COM}) 424 the port converter 402. Thus, power may be transferred from one or more of the modules (PV module 102 or batteries 304) to the inverter bus 110 or reversed and transferred from the inverter bus 110 to one or more of the PV module 102 or the batteries 304. By monitoring the battery conditions, charging or load currents, and the output state, the microcontroller unit 410 may adapt the port converter to maintain any number of rules-based control functions.

Using more conventional terms of volts and current, it is possible to further describe the power flow of the power electronics 302 as follows:

Similarly, the battery power output may be described as follows:

V_{BAT}*I_{BAT}=P_{BAT}. (Equation 5)

Further, the PV power output may be described as follows:

V_{PV}*I_{PV}=P_{PV}. (Equation 6)

In the forward mode depicted in FIG. 6, the port voltage (V_{PORT}) 604 can be regulated to a specific target value by the microcontroller 410 via PWM signals. The microcontroller 410 may adapt the PWM signals to the controllers 402 to maintain a port voltage (V_{PORT}) 604 at a determined voltage level. If an external load or source pushes power into or pulls power from the port, power may flow into or out of the port. Consequently, the power must flow into, or come from the common voltage (V_{COM}) 424 at the shared or common port 430 (i.e. to or from another port). The common voltage (V_{COM}) 424 at the shared or common port 430 may be adapted as necessary, by adjusting the PWM signals to control the voltages to achieve a determined power flow.

Since the PWM ratio will be regulated by the port converters 402 to maintain the voltage at any given port, the common voltage (V_{COM}) will change as needed to facilitate moving the power through the power converter 302.

In an example, when applied to the PV port 404 and regulated by the MCU 410 using PWM signals, a maximum power point tracking algorithm may be used to perturb the PV voltage (P_{PV}) 310 at the PV module 102 until the MCU 410 determines that a selected power (in some instances a maximum power) is being extracted from the PV module 102. In this example, the MCU 410 may maintain a duty cycle of the power converter 402 until the voltage at the output (shared or common port 430) of the port converter 402, i.e., V_{COM} 424, is such that the power may be transferred to a load, which in this case could be into the one or more batteries 304 or to the inverter bus 110. Other implementations are also possible.

By utilizing the power electronic 302 in a forward mode on the I/O port 406, combined with the PV module 102 and the battery 304 and their associated port controllers 402 as described above, the I/O port 406 can push power to or pull power from the PV module 102, the one or more batteries 304, or both. In practice, the power electronics 302 may allow power to be directed to or from any port, as desired, based on control signals from the MCU 410.

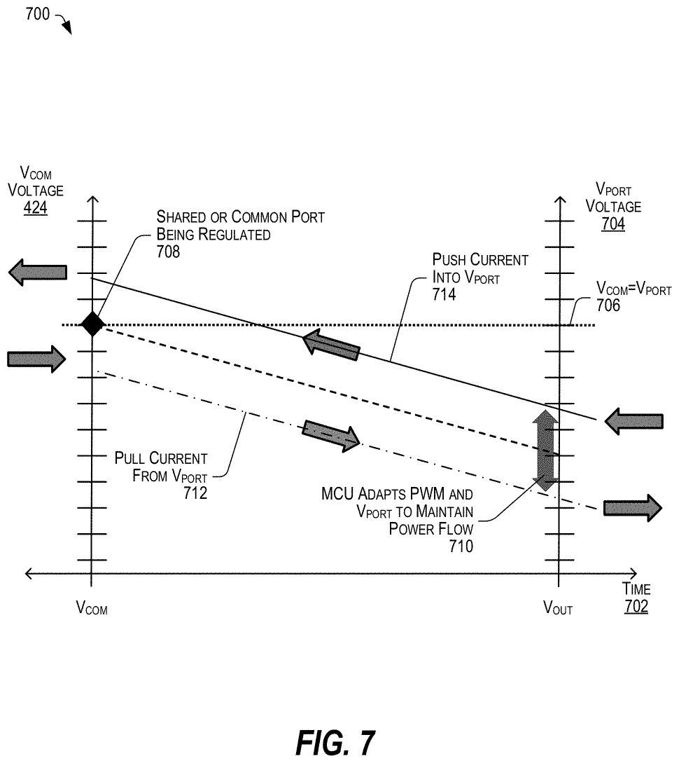

FIG. 7 depicts a graph 700 of voltage (V_{COM} 424 and V_{PORT} 704) versus time 702 for the power electronics 304 in a reverse mode, in accordance with certain embodiments of the present disclosure. In the reverse mode, the microcontroller 410 may control the PWM signals to maintain the port voltage V_{PORT} 704 by regulating the common voltage (V_{COM}) to a specific target value. In the illustrated example, the diamond 708 represents the port being regulated. The microcontroller 410 may maintain the target voltage level at the shared or common port 430. Thus, if an external load or source pushes power into or pulls power from the output port of a port converter, the shared or common port 430 will push up or pull down on the port voltage (V_{PORT}) 704, causing power to flow into or out from the port.

For example, the MCU 410 may regulate the shared or common port 430 to manage the common voltage (V_{COM}) 424 using one or more of the port converters 402. When this is done, any attempt to push power into, or pull power from, the shared or common port 430 causes the shared or common port 430 to transfer power into, or from, the attached port. If this concept is applied to the battery port 408, one of the PV Port converter 402(1) or the output port converter 402(3) may transfer power to the shared or common port 430 and to the battery port 408.

In the illustrated examples of FIGS. 6 and 7, one of the ports is regulated (e.g., 608 or 708), and the other port will adapt to whatever voltage level is required to transfer the power at the regulated port. In In this way, by regulating a specific port, the other port can be controlled to transfer the power. Typically, one of the port converters 402 will regulate the shared or common port 430, though that is not required. In some implementations, the shared or common port 430 may be allowed to float within predetermined limits to optimize bridging between the port converters 402.

In some implementations, the relative “Voltage Targets” may be shifted or adjusted by adapting the duty-cycle of the PWM signals driving the respective switches. By using this adaptive power flow control, the above-described modes of operation may be enabled.

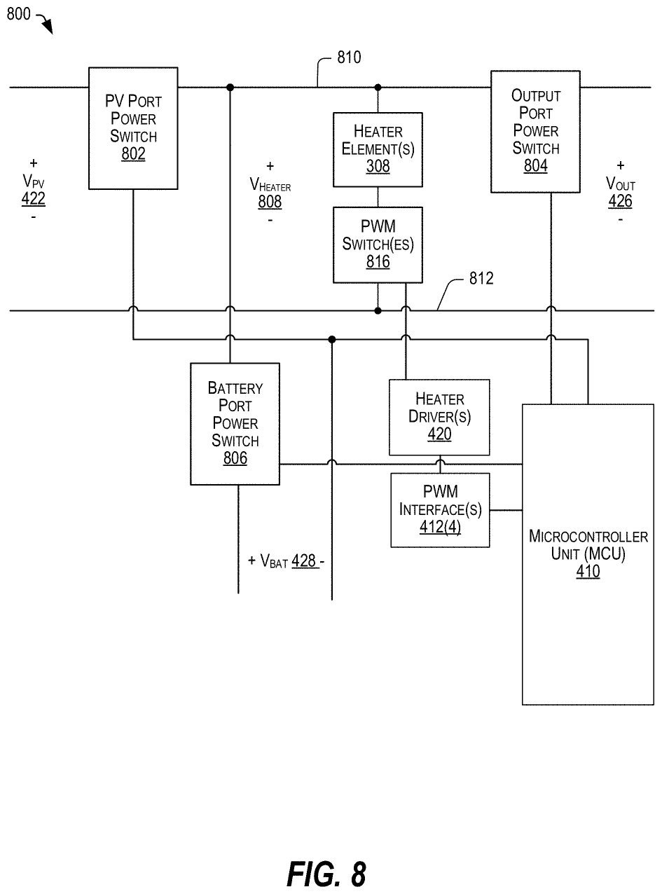

FIG. 8 depicts a block diagram 800 of the power electronics 302 including a fourth port to power one or more heater elements 814, in accordance with certain embodiments of the present disclosure. In this example, a PV port power switch 802 may be coupled between a PV port converter 402(1) and a node 810 coupled to the one or more heater elements 814. An output port power switch 804 may be coupled between the port converter 402(3) and the node 810. Similarly, a battery port switch 806 may be coupled between the node 810 and a first conductor coupled to the one or more batteries 304. A second conductor is coupled to the node 812 and to the one or more batteries 304. Other implementations are also possible.

In this example, the one or more heater elements 308 may include a first conductor coupled to the node 810 and a second conductor coupled to first conductors of one or more PWM switches 816. The one or more PWM switches 816 may include a second conductor coupled to a node 812 and third conductors coupled to outputs of one or more heater drivers 420. The heater drivers 420 may include inputs coupled to one or more PWM interfaces 412(4), which may be controlled by MCU 410. The voltage between the nodes 810 and 812 may be equal to a heater voltage (V_{HEATER}) 808.

The illustrated example, the power electronics 302 includes an additional power flow destination, namely the one or more heater elements 308. The one or more heater elements 308 may be powered from the PV power switch 802, the battery port power switch 804, the output port switch 806, or any combination thereof. Power to the one or more heater elements 308 may be controlled by the one or more PWM switches 816 coupled to the heater elements 308. For example, the MCU 410 may control the PWM interface 412(4) to provide a PWM signal to a heater driver 420, which drives the PWM signal to the PWM switch 816 to control the heater element 308.

By allowing any of the ports to supply power to the heater element 308, power for the heater elements 308 may be pulled from the I/O port 406 when it may not be safe to draw power from the battery 304 due to low temperatures. Further, power for the heater elements 308 may be drawn from the PV port 404 if sunlight is available, or from the battery port 408. This allows the power electronics 302 to maintain a selected temperature under various operating conditions based on signals from the MCU 410. The heater elements 308 may be controlled with PWM control signals to maintain desired levels of heating.

The heater elements 308 may be activated at any time when a temperature of the battery 304 or entire system is determined to be lower than a predetermined threshold temperature related to reliable or safe operation. The one or more heater elements 308 may be activated by activating one or more of the power switches 802, 804, and 806. The MCU 410 may control the PWM interfaces 412(4) to provide PWM signals to control the PWM switches 816 to regulate the one or more heater elements 308 to maintain battery temperatures or overall system temperatures at a temperature level that is above the threshold temperature.

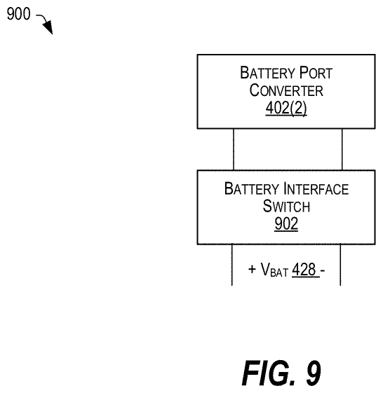

FIG. 9 depicts a block diagram of a portion 900 of a battery interconnect circuit that may provide a battery disconnect and soft-connect feature, in accordance with certain embodiments of the present disclosure. The portion 900 may include the battery port converter 402(2) including a first pair of conductors coupled to the shared or common port 430. The battery port converter 402(2) may further include a pair of conductors coupled to the battery port 408 through a battery interface switch 902.

The battery interface switch 902 may allow full disconnection of the one or more batteries 304 for servicing. Further, the battery interface switch 902 may allow for paralleling of the batteries 304 (the battery systems), internally or externally, through the I/O port 406, and detection of conditions requiring battery charge adaptation. In an example, the battery interface switch 902 may be controlled by PWM signals from the MCU 410 to allow for a mismatched battery to be placed into the system without surge currents during connection. Once connected, the mismatched battery can be coupled through a hard connect switch and the mismatch may be adapted by the PWM signals to balance the charges in the system.

The battery interface switch 902 may be coupled between the battery 302 and the battery port converter 402(2). The transistors 534 and 546 (in FIG. 5) include internal bulk diodes in parallel with the transistor 534 (usually a metal-oxide semiconductor field effect transistor (MOSFET)) allowing current to flow from the battery port 408 to the shared or common port 430, so a battery disconnect switch within the battery interface switch 902 may be wired in a reverse direction, as a back-to-back switch, to enable a full disconnect.

FIG. 10 depicts a diagram of a battery soft connect circuit 1000 that may be included in the power electronics 302, in accordance with certain embodiments of the present disclosure. In this example, the battery port 408 is on the right in the drawing. The circuit 1000 includes a soft connect transistor 1010 including a first conductor coupled to the node 538, a gate coupled to the MCU 410 to receive a soft connect signal 1018, a second conductor coupled to a node 1008, and a reversed bulk diode 912. The circuit 1000 may further include a resistor 1006 coupled between the node 1008 and a node 1002, which may be coupled to the battery port converter 402(2).

The circuit 1000 may further include a hard connect transistor 1014. The hard connect transistor 914 may include a first conductor coupled to the node 538, a gate coupled to the MCU 410 to receive a hard connect signal 920, a second conductor coupled to the node 1002, and a reversed bulk diode 1016. The hard connect transistor 1014 may be activated for main power flow.

In some implementations, if both transistors 1010 and 1014 are turned off, the battery 304 is disconnected from the battery port converter 402(2). The reversed direction of the bulk diodes 1012 and 1016 provide back-to-back disconnection. The soft connect transistor 910 may be used to measure battery conditions at initialization and to determine PWM adjustments prior to enabling primary power flow to or from the battery 304. The circuit 1000 may allow for implementation of large arrays of battery-based systems, which may work together without significant or potentially unsafe power surges between mismatched batteries. The initial power surges may be limited to near zero, and the system may adapt to balance the batteries 304 across the entire array under managed and safe control via the circuit 1000.

Upon initialization of the system, the PWM interfaces would be initialized by the MCU 410, and the battery 304 may be placed in a soft-connect configuration, per the soft-connect transistor 910 and the series resistor 906. Currents in the battery 304 would be limited, and measured (for example, across the series resistor 906, and the battery port converter 402(2) may be controlled by the PWM signals to adjust the output until the current battery current (I_{BAT}) is below a current threshold to prevent surge currents upon connection. Subsequently, the hard connect transistor 914 may be activated to couple the battery 304 to the battery port converter 402(2) for normal operation.

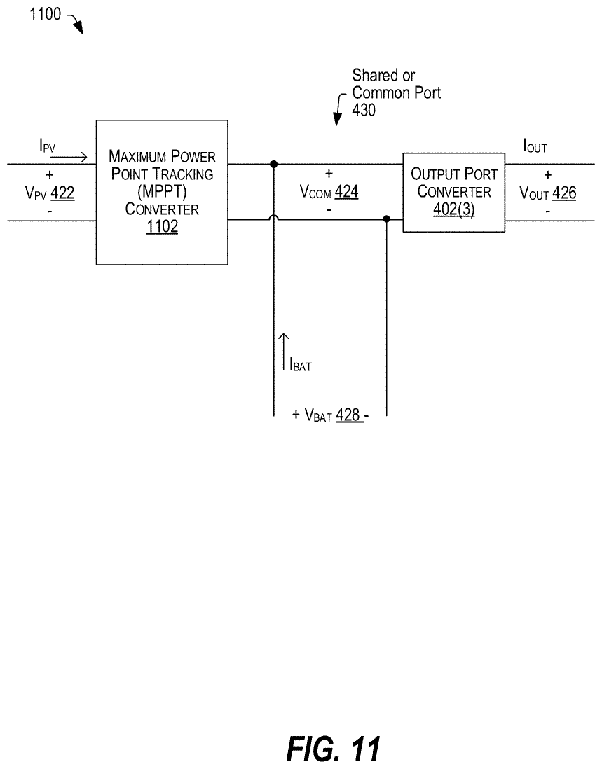

FIG. 11 depicts a block diagram of power electronics 302 with a port converter 1102 and an output port converter 402(3) and without a battery port directly coupled to a shared or common port 430, in accordance with certain embodiments of the present disclosure. In this example, the battery voltage (V_{BAT}) 428 may be directly coupled to the shared or common port 430. The output port converter 402(3) may be coupled between the shared or common port 430 and the I/O port 406 to provide an output voltage (V_{OUT}) 426. Further, the port converter 1102 may be coupled between the PV module 102 and the shared or common port 430.

In this example, the port converter 1102 may be controlled by the MCU 410 to provide a maximum power point tracking (MPPT) function. While all power flow considerations described above can still be maintained, the battery port converter 402(2) is removed, and the shared or common port 430 becomes the battery port. In this configuration, the battery 304 is always connected. While this configuration provides less flexibility in terms of disconnection of the batteries 304 and power management overall, the configuration may be useful in cost reduced scenarios where the loss of flexibility in power control is acceptable.

FIG. 12 depicts a block diagram of a system 1200 including a PV array and a control system 1204 configured to communicate via a network 1206, in accordance with certain embodiments of the present disclosure. The PV array may include a plurality of PV strings with storage 102, each of which may include one or more PV modules 104, power electronics 302, and one or more batteries 304, which may be coupled to a power grid through one or more inverters 1202.

The control system 1204 may communicate with the power electronics 302, the one or more batteries 304, and the one or more inverters 1202 through the network 1206. In some implementations, the control system 1204 may be an array specific or a local computing device. In other implementations, the control system 1204 may be implemented as a “cloud-connected” computing device or a computer server.

The control system 1204 may include one or more network interfaces 1208 configured to communicate with the network 1206. The control system 1204 may also include one or more processors 1210 coupled to the network interfaces 1208 and to a memory 1212. The memory 1212 may include a solid-state memory device, a magnetic memory device, an optical memory device, or any combination thereof. The memory 1212 may store data and processor-executable instructions.

The memory 1212 may include an analytics module 1214 that may cause the processor 1210 to receive data from one or more PV strings with storage 102 and to process the data to determine a plurality of parameters associated with each of the PV modules 102. Further, the memory 1212 may include a PV control module 1216 that may control one or more attributes of each of the PV strings with storage 102 to control operation of the system.

The memory 1212 may further include a data store 1218, which may store PV data 1220 received from each of the PV strings with storage 102 and the associated one or more inverters 1202 and which may store battery data 1222 from the batteries 304.

In other embodiments, the control system 1204 may be an array specific base station (or a base station specific to the region of the array), which may monitor the status and conditions of both the power electronics 302 and the batteries 304 across the array as well as the status of one or more inverters 1202 attached to the array of PV strings with storage 102. The control system 1204 may provide sophisticated control for improved energy management and improved battery State of Charge (SoC) and/or State of Health (SoH) management and monitoring of the system.

In still other embodiments, the control system 1204 may be a base station, or a cloud connected server, which may include one or more algorithms that may be used to determine how power flow is directed within the array between the PV strings with storage 102, from the PV strings with storage 102 to the inverter(s) 1202, from the inverter(s) 1202 to the PV strings with storage 102, bi-directionally to and from an attached power grid, or any combination thereof. The control system 1204 may be implemented as a master to the PV strings with storage 102, or as slave to an attached energy value-based management system or slaved to the inverter(s) 1202 for such decision-making. Other implementations are also possible.

In conjunction with the systems, circuits, and methods described above with respect to FIGS. 1-12, a power electronics and storage device is described that may include a PV port configured to couple to a PV module, an I/O port configured to couple to a bus (such as an inverter bus), and a battery port configured to couple to one or more batteries. The power electronics and storage device may further include a shared or common port that is coupled to each of the PV module, the I/O port, and the battery port. Further, the power electronics and storage device may include an MCU configured to control operation of the PV port, the I/O port, and the battery port to control power flow to, from, and between any of the ports.

In some implementations, the MCU may control one of the I/O port or the shared or common port to maintain a desired power flow. In an example, the PV port and the battery port may be activated to drive power into the shared or common port to maintain power flow through the I/O port. In another example, the battery port may be controlled to increase the voltage at the shared or common port to drive power into the PV module through the PV port to heat the PV module (for example, to de-ice or defrost the PV module). Other implementations are also possible. For example, the power electronics and energy storage system may apply power into PV port to quickly discharge the available energy in the battery in the event of a grid outage to maintain a safe battery level, such as in a local or building fire event.

Although the present invention has been described with reference to preferred embodiments, workers skilled in the art will recognize that changes may be made in form and detail without departing from the scope of the invention.

What is claimed is:

1. A power electronics and storage system comprising:
a photovoltaic (PV) port to couple to a PV module;
a battery port to couple to one or more batteries;
an input/output (I/O) port to couple to a power bus;
a shared port;
a PV port converter coupled between the PV port and the shared port;
a battery port converter coupled between the battery port and the shared port;
an output port converter coupled between the I/O port and the shared port; and
a microcontroller (MCU) coupled to the PV port converter, the battery port converter, and the output port converter to control one of a port voltage at the I/O port and a common voltage at the shared port to manage power flow to, from, and between the PV port, the battery port, and the I/O port.

2. The power electronics and storage system of claim 1, wherein the MCU controls one or more of the PV port converter, the battery port converter, or the output port converter to provide one or more of a first mode, a second mode, a third mode, and a fourth mode.

3. The power electronics and storage system of claim 2, wherein, in the first mode, the MCU sends one or more control signals to regulate an output voltage at the I/O port to provide a voltage/current curve to control a power level of a maximum power point tracking (MPPT) converter coupled to the I/O port.

4. The power electronics and storage system of claim 2, wherein:
the battery port is coupled to a Lithium-type battery; and
in the second mode, the MCU sends one or more control signals to regulate an output voltage at the I/O port to provide a voltage/current curve that corresponds to a state of charge to voltage curve of a specified battery.

5. The power electronics and storage system of claim 2, wherein, in the first mode, the MCU sends one or more control signals to regulate an output voltage at the I/O port to track a battery voltage multiplied by a scaling factor to emulate a series stack of batteries.

6. The power electronics and storage system of claim 2, wherein the MCU is configured to receive a signal from a control system and to regulate and output voltage at the I/O port to manage a power level in response to the signal.

7. The power electronics and storage system of claim 1, wherein each of the PV port converter, the battery port converter, and the output port converter comprises:
a first transistor including:
a first conductor coupled to the shared port;
a second conductor coupled to a first node that is coupled to one of the PV port, the battery port, or the I/O port; and
a gate coupled to the MCU; and
a second transistor including:
a first conductor coupled to the second conductor of the first transistor;
a second conductor coupled to a second node of the shared port; and
a gate coupled to the MCU.

8. The power electronics and storage system of claim 1, wherein the MCU controls one of the battery port converter and the output port converter to increase the common voltage of the shared port to drive power through the PV port converter and into the PV module to heat the PV module or to discharge a battery when a load is not active on the I/O port.

9. The power electronics and storage system of claim 1, wherein the MCU controls one of the PV port converter and the output port converter to increase the common voltage of the shared port to drive power through the battery port converter and the battery port to charge one or more batteries.

10. The power electronics and storage system of claim 1, further comprising:
one or more heating elements; and
one or more switches coupled to the MCU and configured to selectively activate the one or more heating elements to maintain a selected temperature range around the battery.

11. The power electronics and storage system of claim 1, further comprising a battery switch responsive to the MCU and configured to operate in parallel, series, or any combination of series—parallel configurations.

12. A system comprising:
a plurality of power electronics and storage systems, each power electronics and storage system coupled to one or more photovoltaic (PV) modules, one or more batteries, and an output power bus, each power electronics storage and storage system including power electronics configured to control a voltage/current curve at an output port according to a selected operating mode of a plurality of operating modes; and
a control system communicatively coupled to the plurality of power electronics and storage systems,

13. The system of claim 12, wherein:
the selected operating mode is selected in response to a signal from the control system; and
the selected operating mode of each power electronics and storage system is controlled independently from operating modes of others of the plurality of power electronics and storage systems.

14. The system of claim 12, wherein:
the selected operating mode is a PV mode; and
in the PV mode, the MCU sends one or more control signals to regulate the voltage/current curve at the output port to provide the voltage/current curve to control a power level of a maximum power point tracking (MPPT) converter coupled to the I/O port.

15. The system of claim 12, further comprising:
a battery port coupled to one or more Lithium-type batteries;
wherein the selected mode is a battery emulation mode; and
wherein, in the battery emulation mode, the MCU sends one or more control signals to regulate an output voltage at the I/O port to provide the voltage/current curve that corresponds to a state of charge to voltage curve of a Lead-Acid battery.

16. The system of claim 12, wherein, in a battery cell scaling mode, the MCU sends one or more control signals to regulate the voltage/current curve at the output port to track a battery voltage multiplied by a scaling factor to emulate a series stack of batteries.

17. The system of claim 12, wherein, in a parallel and series mode, the MCU is configured to receive a signal from a control system and to regulate the voltage/current curve at the output port to manage a power level in response to the signal.

18. A system comprising:
a power electronics device comprising:
a photovoltaic (PV) port to couple to a PV module;
a battery port to couple to one or more batteries;
an input/output (I/O) port to couple to a power bus;
a shared port coupled to the battery port;
a PV port converter coupled between the PV port and the shared port;
an output port converter coupled between the I/O port and the shared port; and
an microcontroller (MCU) coupled to the PV port converter and the output port converter to control one of a port voltage at the I/O port and a common voltage at the shared port to manage power flow to, from, and between the PV port, the battery port, and the I/O port.

19. The system of claim 18, wherein the microcontroller is configured to control a voltage at one or more of the PV port, the battery port, the I/O port, and the shared port to provide one or more of a PV emulation mode, a parallel and series connection mode, a battery emulation mode, and a battery cell voltage scaling mode.

20. The power electronics of claim 18, further comprising:
a control system communicatively coupled to a plurality of power electronics devices including the power electronics device; and
wherein each power electronics device of the plurality of power electronics devices includes a network transceiver coupled to a network, each power electronics device configured to communicate data to and receive data and instructions from the control system through the network.
